(19) United States
(12) Patent Application Publication
(10) Pub. No.: US 2023/0275371 A1
(43) Pub. Date: Aug. 31, 2023

(54) CONNECTOR DEVICE FOR ELECTRICALLY CONNECTING A FUNCTIONAL MODULE TO A CIRCUIT SUBSTRATE FOR A KEYBOARD, KEYBOARD AND KEYBOARD AND METHOD FOR PRODUCING A KEYBOARD

(71) Applicant: Cherry Europe GmbH, Auerbach i. d. Opf (DE)

(72) Inventor: RUFF Eduard, Auerbach (DE)

(21) Appl. No.: 18/114,154

(22) Filed: Feb. 24, 2023

(30) Foreign Application Priority Data
Feb. 25, 2022 (DE) 10 2022 104 592.7

(51) Int. Cl. H01R 13/115; H01R 12/71; H01R 12/57; H01R 12/58

(52) U.S. Cl. CPC H01R 13/115; H01R 12/71; H01R 12/57; H01R 12/58; H01R 2201/06

(57) ABSTRACT

A connector device for electrically connecting a functional module to a circuit substrate for a keyboard. The connector device comprises two mounting portions arranged in a common plane for mounting the connector device to the circuit substrate in an electrically conductive manner. An insertion opening for pushing through a contact pin of the functional module is formed between the mounting portions. The connector device further comprises two beam portions adjacent to opposite sides of the mounting portions and extending out of the common plane of the mounting portions. The connector device also comprises two contact portions arranged opposite each other for contacting and clamping the contact pin therebetween. The contact portions are arranged between the beam portions, wherein the contact portions are connected to ends of the beam portions facing away from the mounting portions via bending portions. The connector device is integrally formed of electrically conductive material.

The present invention relates to a connector device for electrically connecting a functional module two a circuit substrate for a keyboard, further to a keyboard having several such connector devices, and also to a method for producing such a keyboard.

Various key systems may be employed in keyboards, such as ones used in connection with computers, for example. In particular, key modules may here be connectable to a keyboard circuit board by means of electric connectors. In particular, typical connectors may include a carrier to which two contact pieces for the electrical connection may be attached. The carrier, which is made of plastics, for example, may be attachable to the circuit board, in particular by means of inserting. CN205509070U discloses such a connector.

Against this background, the present invention provides an improved connector device for electrically connecting a functional module two a circuit substrate for a keyboard, an improved keyboard and an improved method for producing a keyboard, according to the main claims. Advantageous embodiments are given in the dependent claims and the subsequent description.

According to embodiments of the approach described here, in particular, there may be provided a connector device that is universally usable in order to electrically connect functional modules, which may also be different if necessary, to a circuit substrate for a keyboard. The connector device may here be formed as an integral punched and bent part, for example. In particular, a connector device may thus be provided as a universal connector for electrically connecting functional modules of different types and/or manufacturers, wherein direct electrically conductive mounting of the connector device to a circuit substrate of the keyboard is possible and an electric contact of the functional module is insertable directly into the connector device.

Advantageously, according to embodiments, overall costs both for the connector device and the electrical connection of functional modules in a keyboard can be lowered, in particular. For example, such connector devices may be produced advantageously using small punching machines with high stroke rates, in particular over 600. For example, multiple falling dies may also be employed here. In particular, investment costs may also be reduced, because only investment in a punching die and optionally also a packaging machine is to be considered. Placement of the connector devices on the circuit substrate may be achieved quickly and reliably with multiple placement heads, for example, because the connector devices are formed to be lightweight. When mounting the connector devices to the circuit substrate, the connector devices may be insensitive to soldering, for example. For electrically connecting a functional module to a circuit substrate, in particular, plastic parts and mounting machines may thus be dispensed with. Hot swap technology or hot swap capability with respect to at least one functional module for a keyboard may be enabled by the connector device. In the context of the hot swap technology, variants of functional modules with alternative switch characteristics or socket materials with improved slippage but low melting temperature can be made possible, because the necessity of a subsequent soldering process can be dispensed with.

What is presented is a connector device for electrically connecting a functional module two a circuit substrate for a keyboard, wherein the connector device comprises:
two mounting portions arranged in a common plane for mounting the connector device to the circuit substrate in an electrically conductive manner, wherein an insertion opening for pushing through a contact pin of the functional module is formed between the mounting portions;
two beam portions adjacent to opposite sides of the mounting portions and extending out of the common plane of the mounting portions; and
two contact portions arranged opposite each other for contacting and clamping the contact pin therebetween, wherein the contact portions are arranged between the beam portions, wherein the contact portions are connected to ends of the beam portions facing away from the mounting portions via bending portions,
wherein the connector device is integrally formed of electrically conductive material.

The keyboard may be provided for a computer or the like, for example. The keyboard may comprise at least one functional module. The circuit substrate may also be referred to as a conductor board, circuit board or the like. The connector device may be formed to be symmetrical, with one or two symmetry planes being given. Mounting in an electrically conductive manner may mean producing an adhesive bond, for example by means of soldering. The beam portions may extend transversely, normally or perpendicularly with respect to the common plane of the mounting portions. The contact portions may also be referred to as flat contact portions, contact fingers or the like. Because of the universally employable connector device being mountable to the circuit substrate by the mounting portions, forces occurring when inserting the contact pin may be accommodated uniformly by both mounting portions.

According to an embodiment, each bending portion may bent by or that 90 degrees. More specifically, it may be bent between 90 degrees and 180 degrees. Such an embodiment offers the advantage that safe contacting and clamping of the contact pin by the contact portions can be enabled.

Also, the contact portions may extend obliquely with respect to the beam portions. Such an embodiment offers the advantage that an insertion aid for the contact pin in an insertion movement from the side of the bending portions can be provided.

Furthermore, free ends of the contact portions may be bent away from each other. A distance between the contact portions may at first decrease and then increase again from the bending portions toward the free ends. With the contact pin absent, the contact portions may here contact each other in an elongated contact region, which may extend normally with respect to an axis of an insertion movement of the contact pin. As an alternative, a minimum distance may be present between the contact portions in the contact region. Such an embodiment offers the advantage that insertion slopes for the contact pin in an insertion movement from the side of the free ends can be provided.

Moreover, free ends of the contact portions may extend through the insertion opening. When the connector device is mounted to the circuit substrate, the free ends may extend into a contact hole formed in the circuit substrate. Such an embodiment offers the advantage that insertion of the contact pin of the functional module can be facilitated, and reliability and safety during insertion can be increased.

Also, free ends of the contact portions may be rounded. Here, a radius of curvature of the free ends may be adapted to a radius of curvature of a contact hole formed in the circuit substrate. Such an embodiment offers the advantage that when inserting a non-centrically arranged or deformed contact pin the contact portions with their free ends may be supported on a wall of the contact hole and guide the contact pin to the center of the contact hole by way of the oblique surfaces. Here, the contact portions may accommodate high transverse forces, without being deformed.

According to an embodiment, the mounting portions may comprise planar mounting surfaces. The connector device may here be mountable to the circuit substrate by means of surface mounting technology at the mounting surfaces. The mounting surfaces may be arranged on a side of the mounting portions facing the bending portions or a side facing away from the bending portions. Such an embodiment offers the advantage that the connector device may be placed on the circuit substrate like any other surface-mountable device. In particular, the connector device may be placed on the circuit substrate from a back side or with unilateral placement layout, wherein a soldering process for attaching or arranging the functional module can be dispensed with, whereby a customer-friendly exchange of functional modules is enabled.

Furthermore, the contact portions may be formed to be resilient and biased toward each other. The contact portions may be deflectable by the contact pin. When inserting the contact pin, the contact portions may deform elastically and exert opposing contact forces on the contact pin on opposite contact locations. Such an embodiment offers the advantage that the contact pin may simply be inserted and removed again as necessary, wherein the contact pin may be held safely and reliably in the connector device in the inserted state.

The contact portions may contact each other in an un-deflected state thereof. The un-deflected state of the contact portions means that the contact pin is plugged out of or removed from the connector device.

As an alternative, the contact portions may be spaced apart from each other in an un-deflected state thereof. The un-deflected state of the contact portions means that the contact pin is plugged out of or removed from the connector device.

Moreover, the beam portions may be formed to be resilient. The beam portions may be deflectable by the contact pin. The beam portions may here function as a flat spring. Such an embodiment offers the advantage that contact forces between the contact portions and the contact pin are reduced, and the flexibility of the connector device can be increased. This has advantages at a higher number of insertion cycles or in case of variable contact pin thickness or of deformed contact pins.

Also, the contact portions may be coated with corrosion-resistant metal the electric conductivity and additionally or alternatively resistance to corrosion is higher than that of the material of which the connector device is formed. The metal with which the contact portions may be coated may be tin, silver, gold or the like. Such an embodiment offers the advantage that the contact resistance, safety of contact, number of insertion cycles and working life can be increased. A connector device having such coated contact portions may also be made possible in different variants without investment in machinery by means of differently coated tapes, which may be tin-plated, silver-plated, or gold-plated, for example. Thus, embodiments of the connector device with different qualities may be realized.

According to an embodiment, each contact portion may comprise at its free end at least two fingers for contacting the contact pin. Each contact portion may comprise at its free end at least one slot by which the at least two fingers are separated from each other. In other words, each contact portion may be formed at its free end branched into at least two fingers. Such an embodiment offers the advantage that redundancy of contact can be increased and at least double redundancy can be provided.

Also, the insertion opening may be formed in an annular protective ring, which may be arranged in the common plane of the mounting portions between the same. The protective ring may at least partially cover a contact hole formed in the circuit substrate when the contactor device is mounted to the circuit substrate, wherein the contact hole completely overlaps the insertion opening. Such an embodiment offers the advantage that incorrect mounting of the contact pin can be prevented.

According to an embodiment, when the connector device is mounted to the circuit substrate, at least the contact portions may be arranged to be at least partially inserted into a contact hole formed in the circuit substrate. Moreover, the bending portions and the beam portions may also be arranged so as to be at least partially inserted into the contact hole. Such an embodiment offers the advantage that the electrical connection of the functional module can be realized in a space-saving manner by means of a connector device sized like that, because a subsection up to a majority of the connector device can be mounted in the contact hole.

As an alternative, when the connector device is mounted to the circuit substrate, at least the beam portions may be arranged completely outside of a contact hole formed in the circuit substrate. The bending portions and the contact portions may also be arranged completely and at least partially outside the contact hole, respectively. In particular, only free ends of the contact portions may extend into the contact hole.

What is also presented is a keyboard, with the keyboard comprising:
a circuit substrate;
at least one functional module; and
at least two items of an embodiment of a connector device as mentioned herein, wherein the at least one functional module is electrically connected to the circuit substrate by means of two connector devices.

At least two connector devices as mentioned herein may thus be employed or used in connection with the keyboard, in order to electrically connect at least one functional module to the circuit substrate of the keyboard. The connector devices are directly attachable to the circuit substrate, for example by means of soldering. Optionally, the keyboard may only comprise the circuit substrate and a plurality of items of an embodiment of the connector device as mentioned herein.

According to an embodiment, the at least one functional module may be arranged on a front side of the circuit substrate, and the at least two connector devices may be mounted to a back side of the circuit substrate. The at least two connector devices may be mounted on the back side by means of surface mounting technology, and the at least one functional module may be arranged on the front side by means of through-hole technology.

Also, the at least one functional module may be electrically connectable to the circuit substrate by means of the connector devices during operation of the keyboard. Moreover, the at least one functional module may be removable or exchangeable and thus electrically detachable from the circuit substrate during operation of the keyboard. Such an embodiment offers the advantage that a hot swap possibility for functional modules of the keyboard can be provided.

For example, at least one functional module may be a mechanical key module. Additionally or alternatively, at least one functional module may be a light-emitting diode or another device suitable for through-hole technology. The key module may be part of a key or represent a key. Thus, one key module may be provided per key of the keyboard.

According to an embodiment, free ends of the contact portions of at least one of the connector devices may be rounded concentrically with respect to a contact hole formed in the circuit substrate, extend at least partially into the contact hole and have a clearance with respect to a wall corresponding to a spring excursion of the contact portions upon insertion of the contact pin into the connector device. Such an embodiment offers the advantage that unintentional plastic deformation of parts of the connector device, which may possibly occur upon incorrect insertion, can be prevented, especially because the free ends may be supported on the wall of the contact hole.

What is further presented is a method for producing an embodiment of a keyboard as mentioned herein, wherein the method comprises the steps of:
mounting the at least two connector devices to the circuit substrate in an electrically conductive manner; and
arranging the at least one functional module on the circuit substrate by means of through-hole technology, wherein the at least one functional module is electrically connected to the circuit substrate by means of two connector devices, wherein contact pins of the at least one functional module are clamped by contact portions of the connector devices.

An embodiment of a keyboard as mentioned herein may advantageously be produced by executing the method. The at least one functional module may correspond to or resemble a device with leads. The at least one functional module may be arranged in the contact holes in the circuit substrate by means of through-hole technology or pin-in-hole technology and may be electrically contacted by means of the connector devices mounted in the region of the contact holes.

According to an embodiment, in the step of mounting, the connector devices may be mounted to the circuit substrate at the mounting portions by means of surface mounting technology using a pick-and-place machine. The connector devices may be provided packaged in a belt. Thus, the connector devices may be mounted quickly, accurately and reliably on solder pads of the circuit substrate by means of surface mounting technology or flat mounting technology.

The invention shall exemplarily be explained in greater detail with reference to the appended drawings. In the drawings:

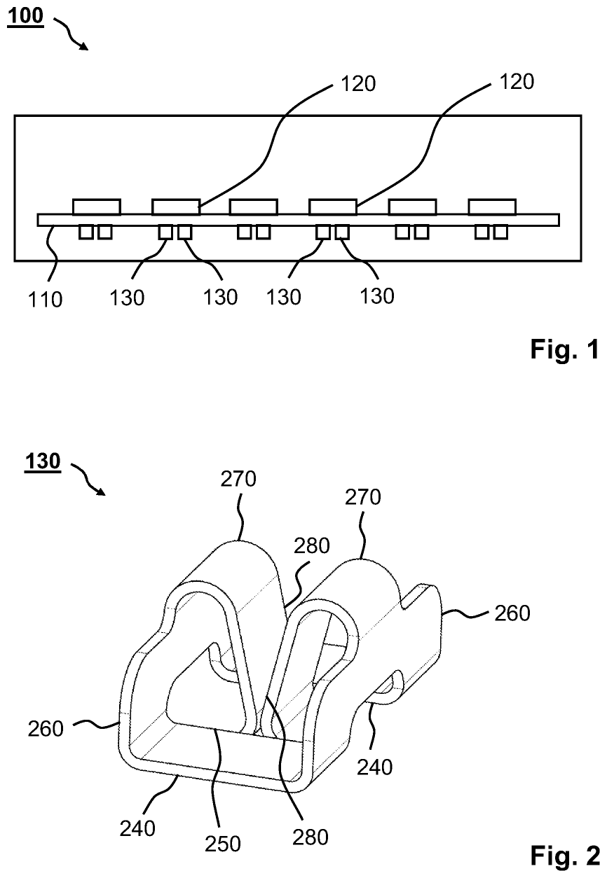

FIG. 1 shows a schematic illustration of a keyboard according to an embodiment of the present invention;

FIG. 2 shows a schematic illustration of a connector device according to an embodiment of the present invention;

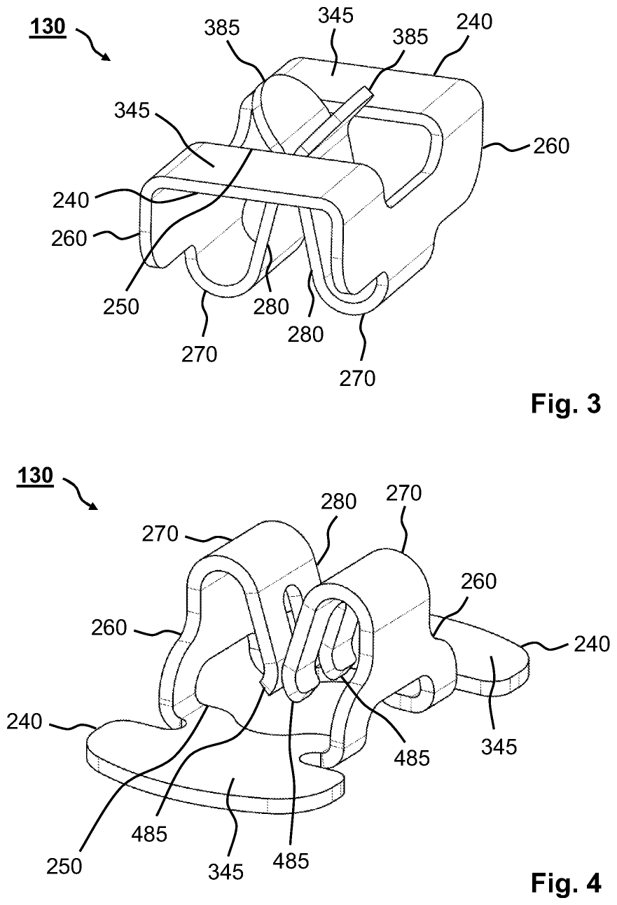

FIG. 3 shows a schematic illustration of a connector device according to an embodiment of the present invention;

FIG. 4 shows a schematic illustration of a connector device according to an embodiment of the present invention;

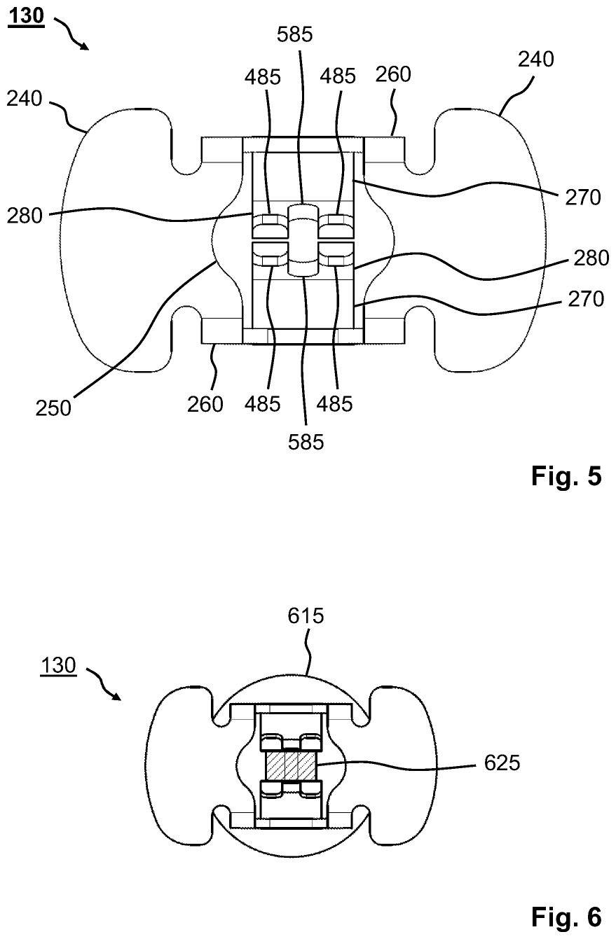

FIG. 5 shows a schematic illustration of a connector device according to an embodiment of the present invention;

FIG. 6 shows a schematic illustration of a connector device according to an embodiment of the present invention;

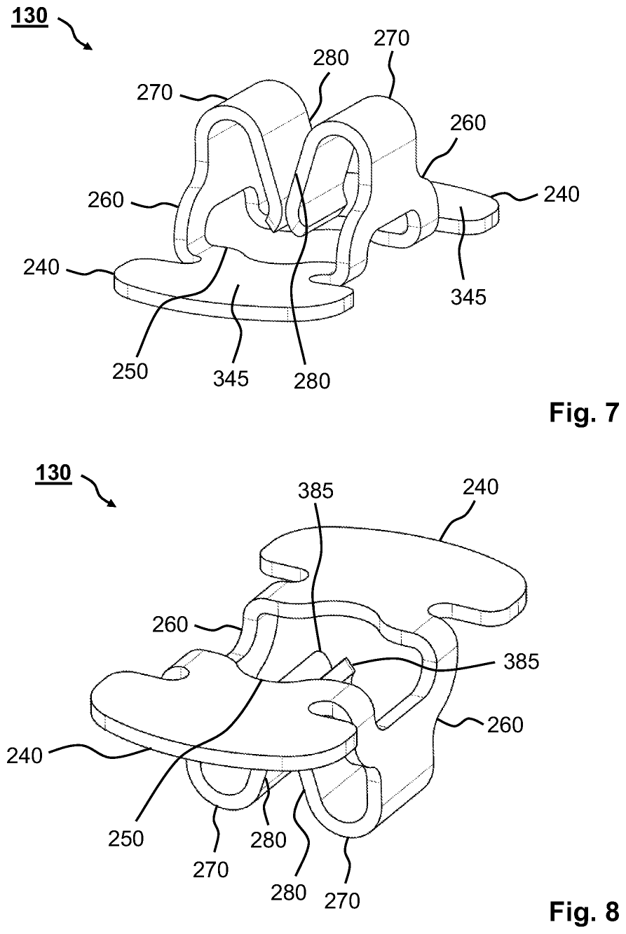

FIG. 7 shows a schematic illustration of a connector device according to an embodiment of the present invention;

FIG. 8 shows a schematic illustration of a connector device according to an embodiment of the present invention;

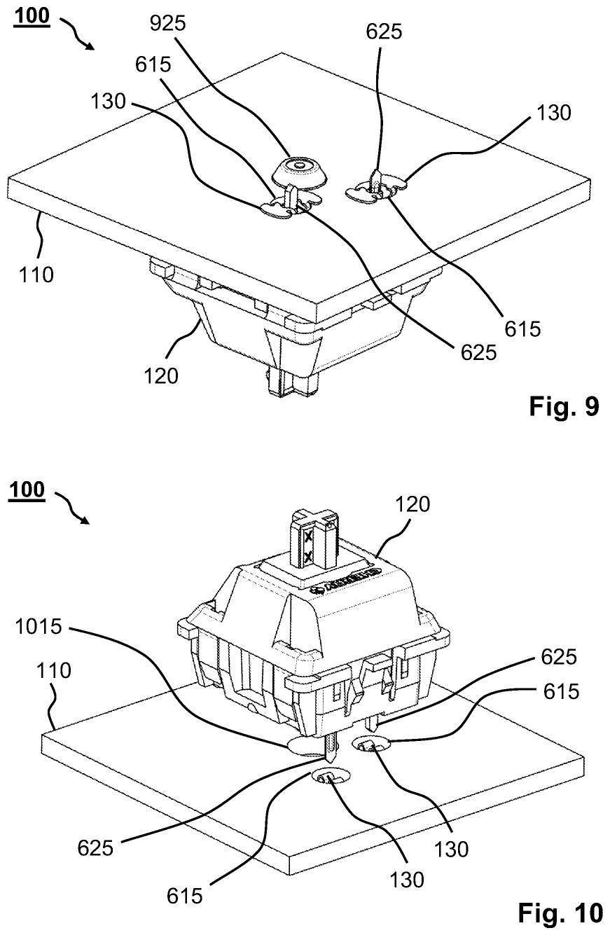

FIG. 9 shows a schematic partial view of a keyboard according to an embodiment of the present invention;

FIG. 10 shows a schematic partial view of a keyboard according to an embodiment of the present invention;

FIG. 11 shows a schematic partial view of a keyboard according to an embodiment of the present invention;

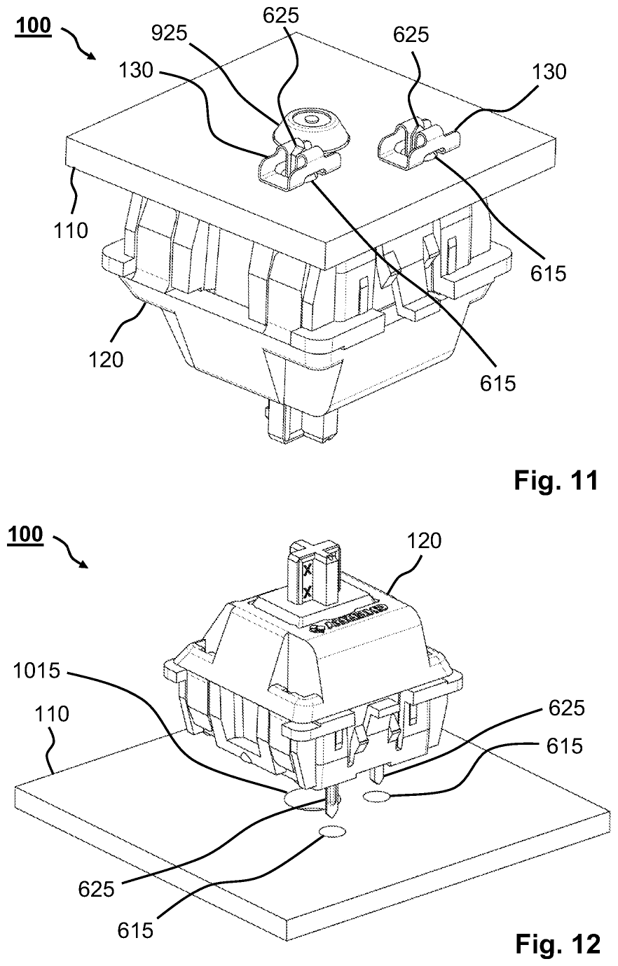

FIG. 12 shows a schematic partial view of a keyboard according to an embodiment of the present invention;

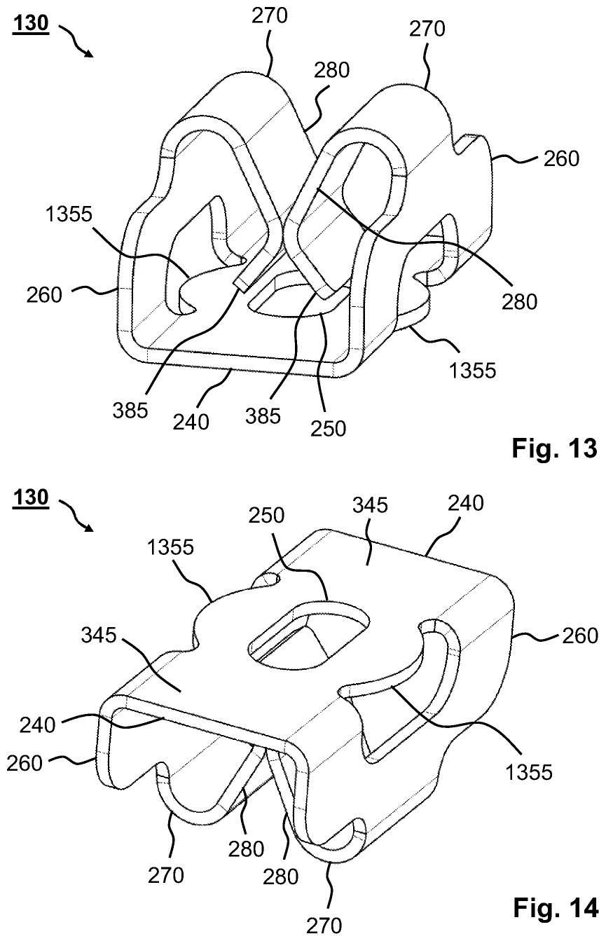

FIG. 13 shows a schematic illustration of a connector device according to an embodiment of the present invention;

FIG. 14 shows a schematic illustration of a connector device according to an embodiment of the present invention;

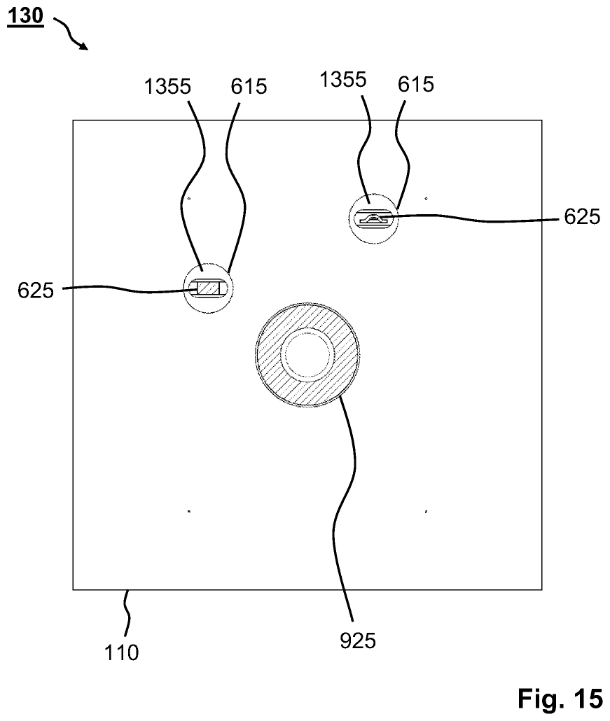

FIG. 15 shows a schematic partial view of a keyboard according to an embodiment of the present invention;

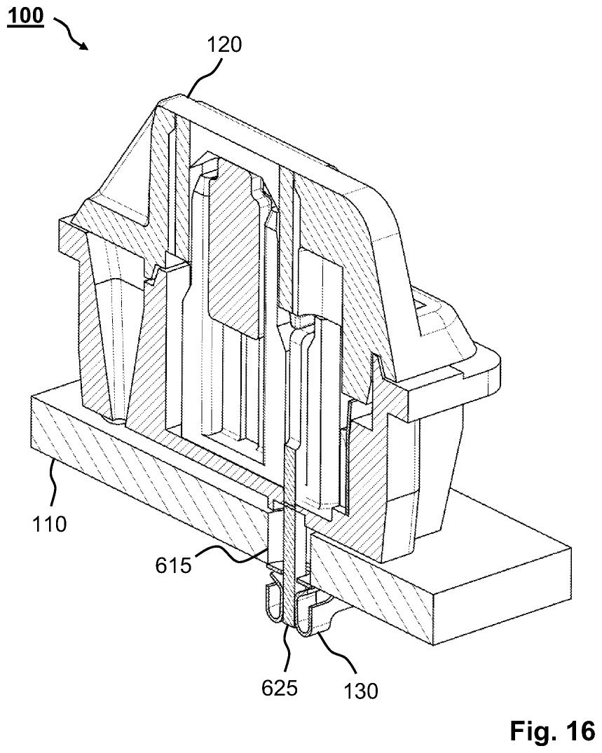

FIG. 16 shows a schematic partial view of a keyboard according to an embodiment of the present invention;

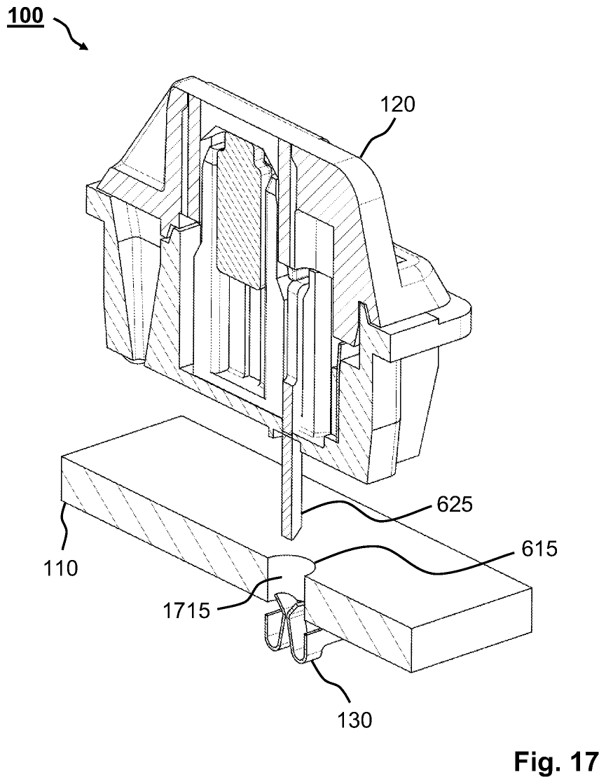

FIG. 17 shows a schematic partial view of a keyboard according to an embodiment of the present invention;

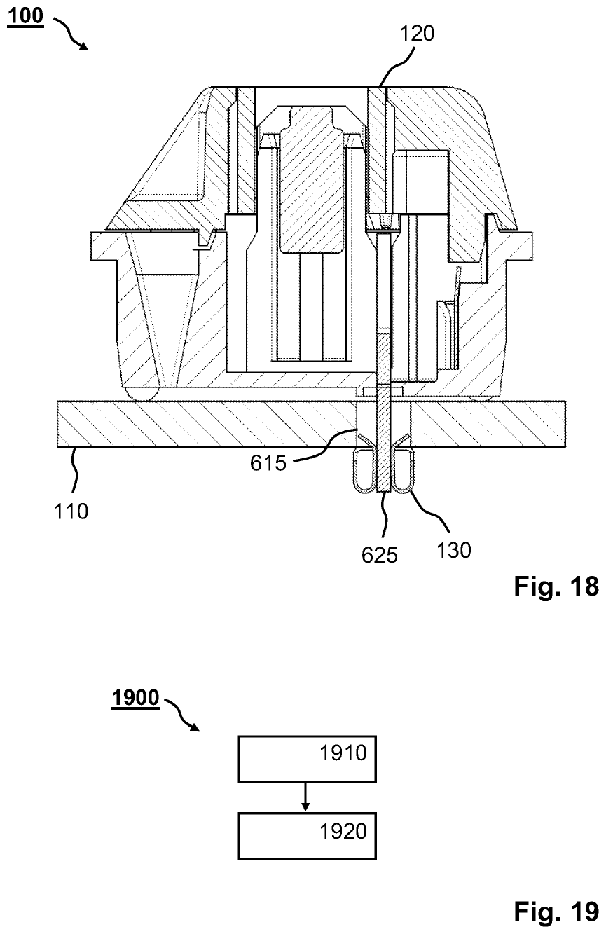

FIG. 18 shows a schematic partial view of a keyboard according to an embodiment of the present invention; and

FIG. 19 shows a schematic flow chart of an embodiment of a method for producing a keyboard.

In the subsequent description of preferred embodiments of the present invention, the same or similar reference numerals are used for the similarly acting elements illustrated in the various figures, with repeated description of these elements being omitted.

FIG. 1 shows a schematic illustration of a keyboard 100 according to an embodiment. For example, the keyboard 100 is part of a notebook computer, laptop computer or the like. As an alternative, the keyboard 100 is configured as a peripheral device for a computer, in particular. The keyboard 100 comprises a circuit substrate 110, at least one functional module 120 and at least two connector devices 130.

The circuit substrate 110 is a conductor board, circuit board or the like, for example. According to the embodiment illustrated in FIG. 1, the keyboard 100 comprises a plurality of functional modules 120 and at least two connector devices 130 per functional module 120. The functional modules 120 are arranged on the circuit substrate 110. The connector devices 130 mounted to the circuit substrate 110. Each functional module 120 is electrically connected to the circuit substrate 110 by means of two connector devices 130. Particularly the connector devices 130 shall be explained in greater detail with reference to subsequent figures.

According to the embodiment illustrated here, the functional modules 120 are arranged on a front side of the circuit substrate 110, and the connector devices 130 mounted on a back side of the circuit substrate 110. According to an embodiment, at least one of the functional modules 120 is configured as a mechanical key module. Additionally or alternatively, at least one of the functional modules 120 is configured as a light-emitting diode or another device suited for through-hole technology. In particular, the functional modules 120 are electrically connectable to the circuit substrate 110 by means of the connector devices 130 during operation of the keyboard 100. Likewise, the functional modules 120 are electrically disconnectable from the circuit substrate 110 by means of the connector devices 130 during operation of the keyboard 100. Thus, the functional modules are exchangeable by means of the connector devices 130, in the sense of the so-called hot swap technology.

In other words, the keyboard 100 comprises multiple connector devices 130 or connectors, wherein the functional modules 120 may be contacted and exchanged by way of plugging or hot swap method.

FIG. 2 shows a schematic illustration of a connector device 130 according to an embodiment of the present invention. The connector device 130 corresponds to or resembles one of the connector devices from FIG. 1 here. Thus, the connector device 130 is configured to enable electric connection of a functional module two a circuit substrate for a keyboard.

The connector device 130 is formed integrally and of an electrically conductive material. The connector device 130 includes two mounting portions 240, insertion opening 250, two beam portions 260, to bending portions 270 and to contact portions 280.

The mounting portions 240 are arranged in a common plane. The mounting portions 240 are formed to enable electrically conductive mounting of the connector device 130 to the circuit substrate of the keyboard. In other words, the connector device 130 is electrically connectable to the circuit substrate of the keyboard at the mounting portions 240.

The insertion opening 250 is formed and arranged between the mounting portions 240. The insertion opening 250 is formed to accommodate a contact pin of the functional module for the keyboard. In other words, a contact pin of the functional module for the keyboard is insertable through the insertion opening 250.

The beam portions 260 are arranged to border on opposite sides of the mounting portions 240. The beam portions 260 extend out of the common plane of the mounting portions 240. More specifically, the beam portions 260 extend transversely or at right angles relative to the common plane of the mounting portions 240. The mounting portions 240 are connected to each other via the beam portions 260. More specifically, the beam portions 260 are connected to the opposite sides of the mounting portions 240 via bends.

A sectional profile of a section through both beam portions 260 and one of the mounting portions 240 is U-shaped. In other words, the mounting portions 240 and the beam portions 264 may body in the shape of a U profile.

The contact portions 280 are arranged opposite each other. The contact portions 280 are connected to ends of the beam portions 260 facing away from mounting portions 240 via bending portions 270. Each contact portion 280 is connected to one of the beam portions 260 via a bending portion 270. The contact portions 280 are arranged between the beam portions 260. The contact portions 280 are formed to contact the contact pin of the functional module for the keyboard and clamp it between the same.

According to the embodiment illustrated here, each of the bending portions 270 has a bend of more than 90 degrees. In other words, each of the bending portions 270 is bent or folded by more than 90 degrees. Thus, the contact portions 280 are bent into the U-profile-shaped body formed by the mounting portions 240 and the beam portions 260 via the bending portions 270. Furthermore, according to the embodiment illustrated here, each of the contact portions 280 extends obliquely with respect to the beam portions 260. Moreover, the contact portions 280 are formed to be resilient and biased toward each other. The contact portions 280 are deflectable by a contact pin of the functional module inserted therebetween. Also, the contact portions 280 are spaced apart from each other in an un-deflected state thereof. As an additional option, the beam portions 260 are formed to be resilient and deflectable by the contact pin. The contact portions 280 are coated by corrosion-resistant metal, for example, the electric conductivity of which is higher than that of the material of which the connector device 130 is integrally formed. The metal of the coating may comprise tin, silver, gold or the like, for example.

FIG. 3 shows a schematic illustration of a connector device 130 according to an embodiment of the present invention. The connector device 130 in FIG. 3 here corresponds to or resembles the connector device from FIG. 2. More specifically, the connector device 130 in FIG. 3 corresponds to the connector device from FIG. 2, with the connector device 130 in FIG. 2 and FIG. 3 merely being shown from different perspectives.

According to the embodiment illustrated here, each of the mounting portions 240 of the connector device 130 comprises a planar mounting surface 345. The mounting surfaces 345 are shown explicitly in the illustration of FIG. 3. According to the embodiment illustrated here, the mounting surfaces 345 are arranged on a side of the mounting portions 240 facing away from the bending portions 270. The connector device 130 is mountable to or replaceable on the circuit device by surface mounting at the mounting surfaces 345.

Furthermore, each of the contact portions 280 has a free end 385. In the illustration of FIG. 3, the free ends 385 are shown explicitly. The free ends 385 are ends of the contact portions 280 facing away from the bending portions 270. According to the embodiment illustrated here, the free ends 385 are bent away from each other. A distance between the contact portions 280 at first decreases and then increases again from the bending portions 270 towards the free ends 385.

Also, the free ends 385 extend through the insertion opening, according to the embodiment illustrated here. In other words, the free ends 385 intersect the common plane of the mounting portions 240.

Furthermore, according to the embodiment illustrated here, the free ends 385 are formed to be rounded. The free ends 385 are approximately concentric to a contact hole formed in the circuit substrate and into which the free ends 385 extend into when the connector device 130 is mounted to the circuit substrate, but have a clearance corresponding to the spring excursion.

FIG. 4 shows a schematic illustration of a connector device 130 according to an embodiment of the present invention. The connector device 130 in FIG. 4 corresponds to or resembles the connector device from FIG. 2 and/or FIG. 3. More specifically, the connector device 130 in FIG. 4 corresponds to the connector device from FIG. 2 and/or FIG. 3, except that each of the contact portions 280 has at least two fingers 485 for contacting the contact pin at its free end, that the mounting surfaces 345 are arranged on a side of the mounting portions 240 facing the bending portions 270, and that the contact portions 280 are arranged completely outside the insertion opening 250. In FIG. 4, the connector device 130 is shown in an oblique view.

In other words, the free ends of the contact portions 280 are slotted and thus branch into the at least two fingers 485 or contact fingers each. Thus, toward its free end, each of the contact portions 280 branches into at least two fingers 485 separated from each other by at least one slot. According to the embodiment illustrated here, each of the contact portions 280 has two fingers 485. Furthermore, the common plane of the mounting portions 240 remains untouched by the fingers 485 for free ends of the contact portions 280.

FIG. 5 shows a schematic illustration of a connector device 130 according to an embodiment of the present invention. In FIG. 5, the connector device from FIG. 4 is shown in a bottom view or top view from below. Furthermore, slots 585 by which the fingers 485 are separated from each other are shown in FIG. 5.

FIG. 6 shows a schematic illustration of connector device 130 according to an embodiment of the present invention. In FIG. 6, the connector device from FIG. 4 and/or FIG. 5 is shown in a state in which the connector device 130 is mounted to the circuit substrate of the keyboard in the region of a contact hole 615 and a contact pin 625 is inserted through the contact hole 615 and into the connector device 130. The contact hole 615 and the contact pin 625 here are shown for illustration. Only the mounting portions of the connector device 130 are arranged outside a region of the contact hole 615. The contact pin 625 is electrically contacted and mechanically clamped between the contact portions, here the fingers of the contact portions, in particular.

With reference to FIG. 4, FIG. 5 and FIG. 6 it is to be noted that the connector device 130 is formed and/or configured to provide at least four opposing contact locations by means of the fingers 485. Thus, an increase in redundancy of contact may be realized.

FIG. 7 shows a schematic illustration of a connector device 130 according to an embodiment of the present invention. The connector device 130 in FIG. 7 corresponds to or resembles the connector device of one of the previously described figures. More specifically, the connector device 130 in FIG. 7 corresponds to the connector device from FIGS. 4 to 6, except that the contact portions 280 are formed continuously or non-slotted. In other words, the free ends of the contact portions 280 are formed to be similar to those of the connector device from FIG. 2 and/or FIG. 3.

FIG. 8 shows a schematic illustration of a connector device 130 according to an embodiment of the present invention. Here, the connector device 130 in FIG. 8 corresponds to the connector device from FIG. 7, with the connector device 130 in FIG. 7 and FIG. 8 merely being shown from different perspectives. In FIG. 8, the free ends 385 of the contact portions 280 are shown explicitly in addition.

FIG. 9 shows a schematic partial view of a keyboard 100 according to an embodiment of the present invention. The keyboard 100 corresponds to or resembles the keyboard from FIG. 1. In FIG. 9, a subsection of the circuit substrate 110, in which by way of example only to contact holes 615 are formed, by way of example only one functional module 120 formed as a mechanical key module or a mechanical key switch and comprising two contact pins 625 and a mounting pin 925, and by way of example only two connect devices 130 are shown of the keyboard 100. In the illustration of FIG. 9, there is shown an oblique view onto a back side of the circuit substrate 110.

Each of the connector devices 130 is mounted to the circuit substrate 110 in the region of one of the contact holes 615, particularly by means of surface mounting technology. The functional module 120 is arranged on the circuit substrate 110 so that the contact pins 625 are inserted through the contact holes 615 and into the connector devices 134 electrically connecting the functional module 120 to the circuit substrate 110, and that the mounting pin 925 is inserted into a through-hole formed adjacent to the contact holes 615 in the circuit substrate 110 for mechanically mounting the functional module 120 to the circuit substrate 110.

FIG. 10 shows a schematic partial view of a keyboard 100 according to an embodiment of the present invention. The keyboard 100 corresponds to or resembles the keyboard from FIG. 9. More specifically, the keyboard 100 corresponds to the keyboard from FIG. 9, with the keyboard 100 merely being shown from different perspectives in FIG. 9 and FIG. 10. In the illustration of FIG. 10, there is shown an oblique view onto a front side of the circuit substrate 110. Moreover, in the illustration of FIG. 10, the functional module 120 is shown prior to plugging into the circuit substrate 110 and into the connector devices 130. Here, the mounting pin of the functional module 120 of the keyboard 100 is obstructed from view owing to the illustration, but the through-hole 1015 into which the mounting pin is plugged is shown in the circuit substrate 110.

With reference to FIGS. 4 through 6 and FIGS. 7 through 10, it is to be noted that each of the connector devices 130 shown there is formed such that, when the connector device 130 is mounted to the circuit substrate 100, at least the contact portions 180 are arranged so as to be at least partially disposed in the contact hole 615. In other words, each of the connector devices 130 shown there is configured so that in the mounted state the contact portions 180 are placed within the contact hole 915 in the circuit substrate 110, with a height of the connector device 130 and particularly the contact portions 280 corresponding to a thickness of the circuit substrate 110.

FIG. 11 a schematic partial view of a keyboard 100 according to an embodiment of the present invention. Here, the keyboard 100, the illustration and the illustrated state in FIG. 11 corresponds to the keyboard, the illustration in the illustrated state from FIG. 9, except that the connector devices 130 correspond to those from FIG. 2 and/or FIG. 3.

FIG. 12 shows a schematic partial view of a keyboard 100 according to an embodiment of the present invention. The keyboard 100 corresponds to or resembles the keyboard from FIG. 11. Here, the keyboard 100, the illustration in the illustrated state in FIG. 12 corresponds to the keyboard, the illustration and the illustrated state from FIG. 10, except that the connector devices 130 correspond to those from FIG. 2 and/or FIG. 3.

With reference to FIGS. 11 and 12 as well as FIGS. 2 and 3, it is to be noted that the connector device 130 shown there is formed such that, when the connector device 130 is mounted to the circuit substrate 110, at least the beam portions 260 are arranged completely outside the contact hole 615. In other words, the connector device 130 shown there is configured so that mounting, in particular surface mounting, takes place on the back side of the circuit substrate 110 and the contact portions 280 are placed at least partially outside the circuit substrate 110.

FIG. 13 shows a schematic illustration of a connector device 130 according to an embodiment of the present invention. The connector device 130 in FIG. 13 corresponds to or resembles the connector device from one of the previously described figures. More specifically, the connector device 130 in FIG. 13 corresponds to the connector device from FIG. 2 and/or FIG. 3, except that the insertion opening 250 is formed in an annular protective ring 1355, which is arranged in the common plane of the mounting portions 240 between the same. The insertion opening 250 is formed to be oval. Furthermore, in the connector device 130 in FIG. 13, as opposed to the connector device from FIG. 2 and/or FIG. 3, the free ends 385 of the contact portions 280 are arranged outside the insertion opening 250 or leave the common plane of the mounting portions 240 untouched. Optionally, according to the embodiment illustrated here, the contact portions 280 contact each other in the un-deflected state thereof.

FIG. 14 shows a schematic illustration of a connector device 130 according to an embodiment of the present invention. The connector device 130 in FIG. 14 here corresponds to or resembles the connector device from FIG. 13. More specifically, the connector device 130 in FIG. 14 corresponds to the connector device from FIG. 13, with the connector device 130 merely being shown from different perspectives in FIG. 13 and FIG. 14. In the illustration of FIG. 14 the mounting surfaces 345 of the mounting portions 240 are also visible owing to the illustration.

FIG. 15 shows a schematic partial view of a keyboard 100 according to an embodiment of the present invention. The keyboard 100 here corresponds to or resembles a keyboard from one of the previously described figures. More specifically, the keyboard 100 corresponds to a keyboard from one of the previously described figures, except that the keyboard 100 comprises connector devices like the connector device from FIG. 13 and/or FIG. 14. In the illustration of FIG. 15, the keyboard 100 is shown in a partially sectional view along a main plane of extension of the circuit substrate 110.

Owing to the illustration, the contact pins 625 and the mounting pin 925 of the functional module and the protective rings 1355 of the connector devices are shown of the keyboard 100 in FIG. 15, apart from a subsection of the circuit substrate 110 with the contact holes 615. The contact pins 625 are plugged into the connector devices, and the mounting pin 925 is inserted in the through-hole of the circuit substrate 110.

FIG. 16 shows a schematic partial view of a keyboard 100 according to an embodiment of the present invention. In FIG. 16, the keyboard 100 from FIG. 15 is shown in a partially sectional view along a sectional plane oriented normally with respect to the main plane of extension of the circuit substrate 110.

Owing to the illustration, a subsection of the circuit substrate 110 with a contact hole 615, a functional module 120 with a contact pin 625, and a connector device 130 are shown of the keyboard 100 here. The connector device 130 is mounted to the back side of the circuit substrate 110, in particular by means of surface mounting technology. The functional module 120 is arranged on the front side of the circuit substrate 110, wherein the contact pin 625 is inserted through the contact hole 615 and into the connector device 130.

With reference to FIGS. 13 through 16, it is to be noted that the connector device 130 shown there is formed such that incorrect mounting of the contact pin 625 of the functional module 120 can be prevented by the insertion opening 250 being formed as a predefined opening in the protective ring 1355, which is in the same plane with the mounting portions 240.

FIG. 17 shows a schematic partial view of a keyboard 100 according to an embodiment of the present invention. The keyboard 100 in FIG. 17 corresponds to or resembles a keyboard from one of the previously described figures. More specifically, the keyboard 100 and the illustration in FIG. 17 corresponds to the keyboard and the illustration from FIG. 16, except that the functional module 120 is shown removed from the circuit substrate 110 and plucked out of the connector device 130, and that another embodiment of the connector device 130 is provided. The connector device 130 in FIG. 17 resembles a connector device from one of the previously described figures, in particular the connector device from FIG. 2 and/or FIG. 3. Here, the keyboard 100 is shown in a partially sectional view in FIG. 17.

The connector device 130 is mounted to the circuit substrate 110 in the region of the contact hole 615. Here, the free ends of the contact portions of the connector device 130 are arranged within the contact hole 615. In other words, the free ends of the contact portions of the connector device 130 are arranged inserted in the contact hole 615. Furthermore, the free ends are rounded. The free ends of the contact portions of the connector device 130 are formed to be rounded concentrically with respect to the contact hole 615, in order to prevent radial deformation of the contact portions and guide the contact pin 625 to the center of the contact hole 615 by the free end abutting on the contact hole 615 when an eccentrically arranged or deformed contact pin 625 is being inserted.

FIG. 18 shows a schematic partial view of a keyboard 100 according to an embodiment of the present invention. FIG. 18 shows the keyboard 100 from FIG. 17 from a perspective rotated relative to FIG. 17, also in a partially sectional view, wherein the contact pin 625 of the functional module 120 is plugged into the connector device 130. It can be seen here that the free ends of the contact portions of the connector device 130 are arranged at a small distance to the wall of the contact hole 615.

With reference to FIG. 17 and FIG. 18, it is to be noted that in the connector device 130 shown there the free ends of the contact portions or the contact finger ends are formed to be V-shaped, the contact portions are rounded concentrically with respect to the contact hole 615 or the circuit board bore at their free ends, at least partially extend into the contact hole 615 and have a distance to the wall 1715 proportional to the spring excursion during insertion. In this way, incorrect mounting of the connector pin 625 can be prevented. When inserting a possibly bent or deformed connector pins 625, the at least one affected end comes to rest on the bore wall or wall 1715 of the contact hole 615. Plastic deformation or damage of the contacts or the contact portions of the connector device 130 may thus be prevented.

FIG. 19 shows a schematic flow chart of an embodiment of a method 1900 for producing a keyboard. The method 1900 for producing is executable to produce a keyboard corresponding to or resembling a keyboard from one of the previously described figures. The method 1900 for producing include a step 1910 of mounting and a step 1920 of arranging.

In the step 1910 of mounting, the at least two connector devices are mounted to the circuit substrate in an electrically conductive manner. Subsequently, in the step 1920 of arranging, the at least one functional module is arranged on the circuit substrate by means of through-hole technology. The at least one functional module is electrically connected to the circuit substrate by means of two connector devices, and contact pins of the at least one functional module are inserted between the contact portions of the connector devices and clamped therebetween.

According to an embodiment, in the step 1910 of mounting, the connector devices are mounted to a circuit substrate at their mounting portions by means of surface mounting technology using a pick-and-place machine. The connector devices are provided packaged in a belt. In other words, the connector devices are packaged in an SMD belt (SMD=Surface-Mounted Device) so as to enable mounting in standard pick-and-place machines.

With reference to the previously described figures, embodiments shall be summarized again and in other words in the following.

The connector device 130 functions as a universal connector. The connector device 130 includes the contact portions 280 or a part for contacting mechanical switches, THT LEDs or other devices or functional modules 120 with THT contact pins on the circuit board or the circuit substrate 110 of the keyboard 100, forms a U-shaped carrier with at least one opening of the insertion opening 150 in the central region. There is a contact portion 280 or flat contact portion each on every beam portion 260. Each contact portion 280 is bent at an angle greater than 90 degrees so that their contact surfaces are opposite from each other. The free ends 385 are opened in a V-shaped manner and form to insertion slopes. To mounting portions 240 are on opposite sides of the contact location and are provided for mounting the connector device 130 on the circuit substrate 110, so that insertion forces can uniformly be accommodated by both mounting portions 240.

According to an embodiment, the at least two mounting portions 240 are formed to be flat and are formed for flat mounting on sold the pads of the circuit substrate 110, in particular by means of SMT methods. According to an embodiment, the contact portions 280 are formed of resilient material, wherein the same elastically deform upon insertion and produce opposing contact forces at both opposite contact locations. According to an embodiment, the beam portions 260 are formed of resilient material and former a flat spring, which is elastically deformed upon insertion and thus promotes the contact forces. Contact surfaces of the contact portions 280 are provided with corrosion-resistant and well electrically conductive metal coating, such as tin, silver, gold etc., in order to increase safety of contact, the number of insertion cycles and working life.

A diameter of the contact hole 615 formed in the circuit substrate 110 is 1.7 millimeters or 3 millimeters, for example. The SMD belt for mounting the connector device 130 by means of standard pick-and-place machines may have a width of 12 millimeters and grid pattern of 4 millimeters.

If an embodiment includes an “and/or” combination between a first feature and a second feature, this may be understood to mean that the embodiment comprises both the first feature and the second feature according to an embodiment and either only the first feature are only the second feature according to a further embodiment.

### REFERENCE NUMERALS

100 keyboard
110 circuit substrate
120 key module
130 connector device
240 mounting portion
250 insertion opening
260 beam portion
270 bending portion
280 contact portion
345 mounting surface
385 free end
485 finger or contact finger
585 slot
615 contact hole
625 contact pin
925 mounting pin
1015 through-hole
1355 protective ring
1715 wall
1900 method for producing
1910 step of mounting
1920 step of arranging

1. Connector device for electrically connecting a functional module to a circuit substrate for a keyboard, wherein the connector device comprises:
two mounting portions arranged in a common plane for mounting the connector device to the circuit substrate in an electrically conductive manner, wherein an insertion opening for pushing through a contact pin of the functional module is formed between the mounting portions;
two beam portions adjacent to opposite sides of the mounting portions and extending out of the common plane of the mounting portions; and
two contact portions arranged opposite each other for contacting and clamping the contact pin therebetween, wherein the contact portions are arranged between the beam portions, wherein the contact portions are connected to ends of the beam portions facing away from the mounting portions via bending portions,
wherein the connector device is integrally formed of electrically conductive material.

2. Connector device according to claim 1, wherein each bending portion is bent by more than 90 degrees.

3. Connector device according to claim 1, wherein the contact portions extend obliquely with respect to the beam portions.

4. Connector device according to claim 1, wherein free ends of the contact portions are bent away from each other.

5. Connector device according to claim 1, wherein free ends of the contact portions extend through the insertion opening.

6. Connector device according to claim 1, wherein free ends of the contact portions are rounded.

7. Connector device according to claim 1, wherein the mounting portions comprise planar mounting surfaces.

8. Connector device according to claim 1, wherein the contact portions are formed to be resilient and are biased toward each other, wherein the contact portions are deflectable by the contact pin.

9. Connector device according to claim 8, wherein the contact portions contact each other in an un-deflected state.

10. Connector device according to claim 8, wherein the contact portions are spaced apart from each other in an un-deflected state.

11. Connector device according to claim 1, wherein the beam portions are formed to be resilient, wherein the beam portions are deflectable by the contact pin.

12. Connector device according to claim 1, wherein the contact portions are coated with corrosion-resistant metal the electric conductivity and/or resistance to corrosion is greater than that of the material of which the connector device is formed.

13. Connector device according to claim 1, wherein each contact portion comprises at its free end at least two fingers for contacting the contact pin.

14. Connector device according to claim 1, wherein the insertion opening is formed in an annular protective ring arranged in the common plane of the mounting portions between the same.

15. Connector device according to claim 1, wherein at least the contact portions are arranged to be at least partially inserted in a contact hole formed in the circuit substrate when the connector device is mounted to the circuit substrate.

16. Connector device according to claim 1, wherein at least the beam portions are arranged to be completely outside a contact hole formed in the circuit substrate when the connector device is mounted to the circuit substrate.

17. Keyboard, wherein the keyboard comprises:
a circuit substrate;
at least one functional module; and
at least two connector devices according to any one of the preceding claims, wherein the at least one functional module is electrically connected to the circuit substrate by means of two connector devices.

18. Keyboard according to claim 17, wherein the at least one functional module is arranged on a front side of the circuit substrate, and the at least two connector devices are mounted on a back side of the circuit substrate.

19. Keyboard according to claim 17, wherein the at least one functional module is electrically connectable to the circuit substrate by means of the connector devices during operation of the keyboard.

20. Keyboard according to claim 17, wherein at least one functional module is a mechanical key module and/or at least one functional module is a light-emitting diode or another component suited for through-hole technology.

21. Keyboard according to claim 17, wherein free ends of the contact portions of at least one of the connector devices are rounded concentrically with respect to a contact hole formed in the circuit substrate, extend at least partially into the contact hole and have a clearance with respect to a wall of the contact hole corresponding to a spring excursion of the contact portions upon insertion of the contact pin into the connector device.

22. Method for producing a keyboard according to claim 17, wherein the method comprises the steps of:
mounting the at least two connector devices to the circuit substrate in an electrically conductive manner; and
arranging the at least one functional module on the circuit substrate by means of through-hole technology, wherein the at least one functional module is electrically connected to the circuit substrate by means of two connector devices, wherein contact pins of the at least one functional module are clamped by contact portions of the connector devices.

23. Method according to claim 22, wherein, in the step of mounting, the connector devices are mounted to the circuit substrate at the mounting portions by means of surface mounting technology using a pick-and-place machine, wherein the connector devices are provided packaged in a belt.
